(19) United States
(12) Patent Application Publication
(10) Pub. No.: US 2025/0207413 A1
(43) Pub. Date: Jun. 26, 2025

(54) LOOSEFILL INSULATION INSTALLATION SYSTEM AND METHOD FOR INSTALLING LOOSEFILL INSULATION

(71) Applicant: CertainTeed LLC, Malvern, PA (US)

(72) Inventors: Bruce A. Hartzell, Mickleton, NJ (US); Juan C. Miranda, Lakeland, FL (US); Alejandro Gonzalez-Alom, Winter Haven, FL (US); Pawan Saxena, Malvern, PA (US)

(21) Appl. No.: 18/989,739

(22) Filed: Dec. 20, 2024

Related U.S. Application Data
(60) Provisional application No. 63/612,792, filed on Dec. 20, 2023.

(51) Int. Cl. E04F 21/08; B02C 18/22

(52) U.S. Cl. CPC E04F 21/085; B02C 18/2216

(57) ABSTRACT

A system for processing insulation material is disclosed. The system includes a hopper having an opening for receiving insulation material and an outlet; at least one chopping blade disposed in the hopper for reducing the size of insulation material; an auger disposed in the hopper for conducting insulation material received in the opening to the outlet of the hopper; and a blower having an inlet coupled to the outlet of the hopper and an outlet. The system also includes a plate operatively disposed between the outlet of the hopper and the inlet of the blower. The plate defining a plurality of apertures, where the plate is configured to preferentially admit insulation material below a threshold size into the blower and preferentially reject insulation material above the threshold size for reintroduction to the hopper and contact with at least one of the chopping blades.

### CROSS-REFERENCE TO RELATED APPLICATIONS

The present application claims the benefit of priority of U.S. Provisional Patent Application No. 63/612,792, filed Dec. 20, 2023, which is hereby incorporated herein by reference in its entirety.

### BACKGROUND OF THE DISCLOSURE

### 1. Field of the Disclosure

The present disclosure relates generally to loose fill insulation installation systems, for example, suitable for processing loose fill insulation for installing at an installation site. The present disclosure relates more particularly to a loose fill insulation fiber sizing plate for standardizing fiber size and/or consistency output from an insulation blowing machine.

### 2. Technical Background

Loose fill insulation is packaged in bags in which the material becomes compacted prior to storage and shipment. When removed from the bags, the insulation remains somewhat compacted, and typically separates into clumps. In order to provide for more effective installation, the insulation material is typically conditioned to increase its volume and to reduce its density. This can involve, for example, contacting the insulation with rotating chopping blades to chop the clumps into smaller pieces and to otherwise provide loft to the material.

However, the loose fill insulation as received from a bag can have clumps of a variety of different sizes. Such a wide distribution in clump sizes can be undesirable. Larger clumps can complicate installation, as they can cause intermittent blockage of the tube used to carry insulation from the blower to the installation site. Clumps tend to be more dense, and thus less insulating than free-flowing insulation, and thus can adversely affect the overall insulation properties of the installed fiber. Moreover, large clumps can result in non-homogeneous deposition which can provide a spatially-varying insulation value within a wall or in an open area to be filled such as an attic.

Further improvements are needed in the art of installation of loose fill insulation.

### SUMMARY OF THE DISCLOSURE

In one aspect, the present disclosure provides a system for processing insulation material comprising:
a hopper having a material feed opening configured to receive insulation material and an outlet;
at least one chopping blade disposed in the hopper, configured to reduce the size of insulation material disposed therein;
an auger disposed in the hopper and configured to conduct insulation material received in the material feed opening of the hopper to the outlet of the hopper;
a blower having an inlet coupled to the outlet of the hopper and an outlet, the inlet of the blower being configured to receive insulation material from the hopper and to blow it through the outlet of the blower; and a plate operatively disposed between the outlet of the hopper and the inlet of the blower, the plate defining a plurality of apertures, wherein
   (a) the plate is configured to preferentially admit insulation material below a threshold size into the blower and preferentially reject insulation material above the threshold size for reintroduction to the hopper and contact with at least one of the chopping blades; and/or
   (b) the apertures of the plate have a maximum dimension no greater than the threshold size.

In another aspect, the disclosure provides a method of processing insulation fibers using the system according to the disclosure, the method comprising:
introducing loosefill insulation material into the hopper;
conditioning the loosefill insulation material by contacting with one or more of the chopping blades to reduce the size of the insulation material;
conveying, via the auger, the reduced-size insulation to the outlet of the hopper;
sizing, using the plate, the reduced-size insulation to preferentially admit insulation material below a threshold size into the blower and preferentially reject insulation material above the threshold size; and
reintroducing rejected insulation material the hopper and contacting it with at least one of the chopping blades.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a perspective cutaway view of a system for processing insulation material according to an embodiment of the disclosure;

FIG. 2 is a cutaway side view of the system for processing insulation material of FIG. 1;

FIG. 3 is a top cutaway view of the system for processing insulation material of FIG. 1;

FIG. 4 is a close up perspective view of a portion of the system for processing insulation material of FIG. 1;

FIG. 4A is a schematic perspective view of a blower portion of the system for processing insulation material of FIG. 1;

FIG. 5 is a perspective view of a slide gate according to an embodiment of the disclosure;

FIG. 6 is a perspective view of a plate according to an embodiment of the disclosure;

FIG. 7 is a perspective view of a plate according to another embodiment of the disclosure;

FIG. 8 is a perspective view of a plate according to another embodiment of the disclosure;

FIG. 9A is a perspective view of a plate according to another embodiment of the disclosure; and

FIG. 9B is a perspective view of a plate according to another embodiment of the disclosure.

FIG. 10 is a plan view of a plate according to another embodiment of the disclosure;

FIG. 11 is a perspective view of a plate according to another embodiment of the disclosure; and

FIGS. 12, 13 and 14 present pictures of samples of insulation material blown in the experiments described herein.

### DETAILED DESCRIPTION

The present inventors have noted that loose fill insulation, especially as provided from bags, may vary in respective individual lengths as well as in clump size. Such variance may result in an uneven distribution and/or density during application (e.g., non-homogenous deposition), as well as an overall more dense material, each of which may adversely impact thermal insulation properties or other properties of the loose fill insulation.

Accordingly, one aspect of the disclosure is a system for processing insulation material that includes a hopper, at least one chopping blade, an auger, a blower, and a plate. The hopper includes a material feed opening configured to receive insulation material and an outlet. The at least one chopping blade is disposed in the hopper and configured to reduce the size of insulation material disposed therein. The auger is disposed in the hopper and configured to conduct insulation material received in the material feed opening of the hopper to the outlet of the hopper. The blower includes an inlet coupled to the outlet of the hopper and an outlet, the inlet of the blower being configured to receive insulation material from the hopper and to blow it through the outlet of the blower. The plate is operatively disposed between the outlet of the hopper and the inlet of the blower. The plate defines a plurality of apertures and is configured to preferentially admit insulation material below a threshold size into the blower and preferentially reject insulation material above the threshold size for reintroduction to the hopper and contact with at least one of the chopping blades.

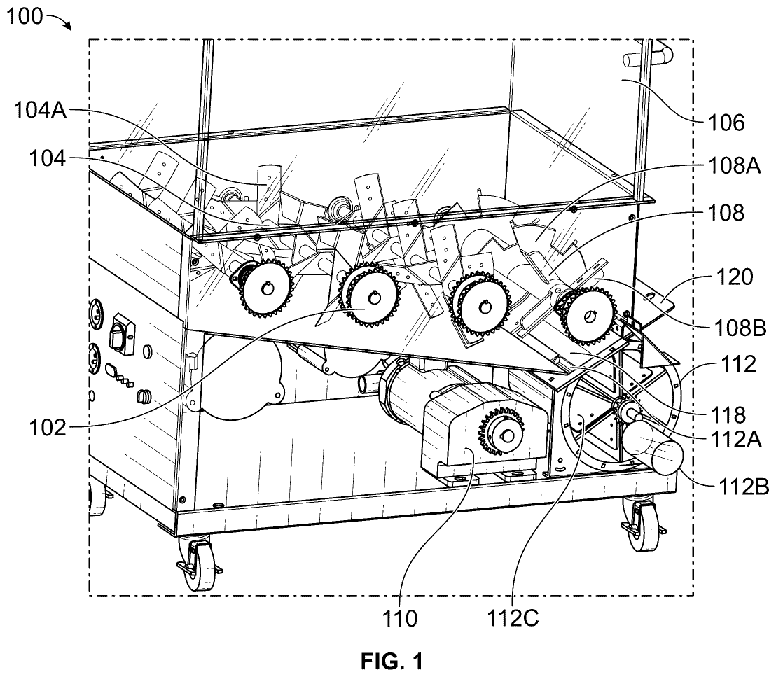

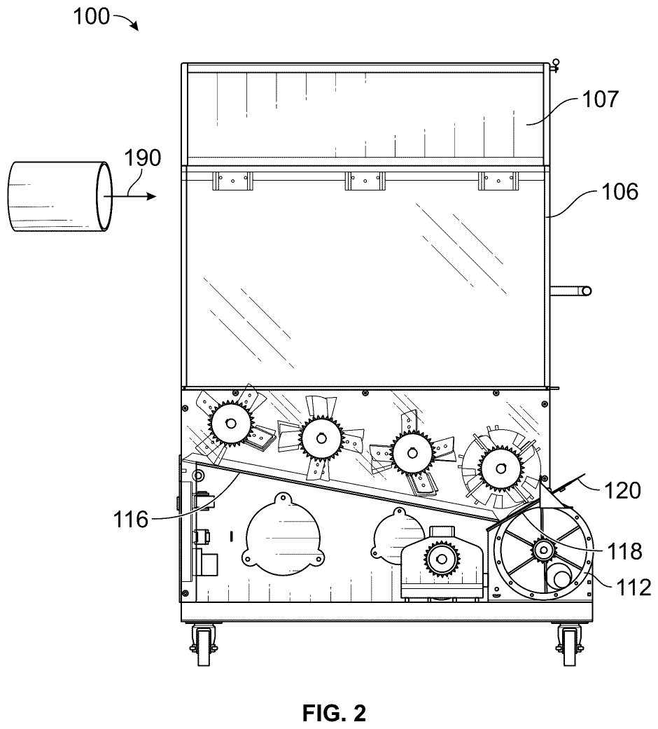

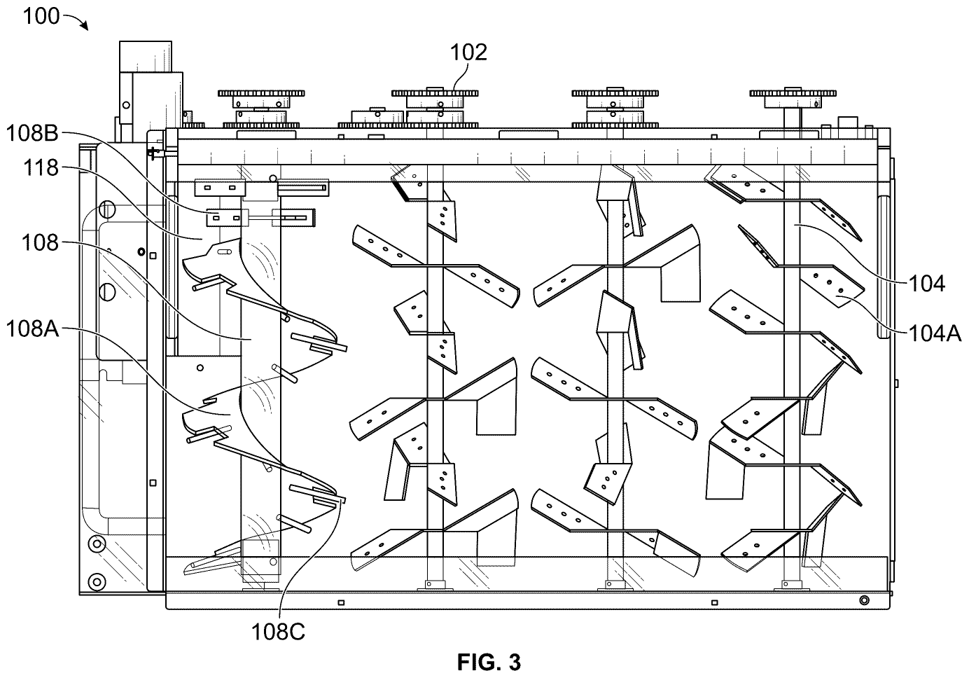

An example system for processing insulation material 100 is shown in FIG. 1 through FIG. 4. The system includes a hopper 106 having a feed material opening 107 and an outlet 118, at least one chopping blade 104A disposed in the hopper 106, an auger 108A disposed in the hopper 106, a blower 112 having an inlet 112A coupled to the outlet 118 and a blower outlet 112B, and a plate 130 disposed between the outlet 118 and the inlet 112A. The at least one chopping blade 104A, the auger 108A, and the blower 112 are operatively coupled to a power source 110 by way of a plurality of sprockets 102. As shown, the hopper 106 includes a pair of substantially vertical end walls and a pair of side walls coupled at a first end to an inclined bottom surface 116. An upper section of the hopper 106 includes the feed material opening 107 that provides an inlet for introducing compacted fibrous material to be shredded by the at least one chopping blades, such as a compacted bale of loose fill insulation material. The feed material opening 107 may operate under gravity to introduce the compacted fibrous material to the chopping blades 104A and/or the auger 108A, such that material input into the feed material opening 107 falls down into the hopper 106 for conditioning.

A lower section of the hopper 106 is defined at a termination end of the inclined bottom surface 116 and includes the outlet 118. The outlet 118 is at a lower end of the inclined bottom surface 116 such that the material is aided by gravity as it is urged toward the outlet 118. Conditioned material from the hopper 106 is output through the outlet 118 to the blower 112. In various embodiments, the inclined bottom surface 116 is coupled at a first end to the outlet 118 and at a second end to the wall, the inclined bottom surface 116 sloping downwardly toward the outlet 118.

At least one chopping blade 104A is in disposed within the hopper 106. As shown, the hopper includes a plurality of chopping blades 104A disposed about a chopping shaft 104. For example, the hopper 106 includes three chopping shafts 104, where each chopping shaft 104 includes a plurality of chopping blades 104A. The chopping blades 104A are longitudinally disposed along the chopping shaft 104 and project radially outward from the chopping shaft 104. Each of the chopping shafts 104 are coupled to opposite walls of the hopper 106, with each of the chopping shafts 104 separated from one another by a distance. The distance of separation between each of the chopping shafts 104 and/or the placement of the chopping blades 104A about each of the respective chopping shafts 104 is such that the chopping blades 104A on one or more chopping shafts 104 do not directly engage one another during operation.

In various embodiments, each of the chopping shafts 104 is coupled at an end to a sprocket 102. For example, each of the chopping shafts 104 in FIG. 1 is coupled to the sprocket 102 residing outside of (e.g., external) the hopper 106. The sprocket 102 is drivingly engaged with the power source 110, for example using a chain, belt, or cable, such that during operation the power source 110 causes rotation of the sprocket 102 which in turn causes rotation of the chopping shafts 104.

The at least one chopping blade is configured to condition the loosefill insulation. This can occur in at least a couple of ways. The at least one chopping blade can increase the overall loft of the loosefill insulation material by working air among individual fibers of the material. But, critically, it can also chop or shred clumps of material to reduce their size.

Thus, the function of chopping blades 104A in the embodiment of FIG. 1 is essentially to condition the insulation material introduced through the feed material opening 107. For example, the at least one chopping blade 104A is configured to reduce the size of insulation material disposed therein. The chopping blades 104A then advance the conditioned (e.g., shredded) material toward the auger 108 disposed proximal to the outlet 118, where the auger 108A conveys the conditioned material toward the outlet 118 for introduction to the blower 112.

In various embodiments as otherwise described herein, at least one pair of chopping shafts 104 are counter rotating. For example, a first chopping shaft rotates in a first direction (e.g., a clockwise direction) and a second chopping shaft rotates in a second direction different that the first direction (e.g., a counter clockwise direction. In such examples, chopping blades 104A disposed on each of the chopping shafts 104 rotate in the direction of the mating chopping shaft 104 such that the pair of chopping blades 104A are counter rotating.

For example, in various embodiments, a first plurality of chopping shafts 104 rotate in the first direction and a second plurality of chopping shafts 104 rotate in the second direction. In various embodiments, at least one chopping shaft 104 is counter rotating with the auger 108A. Counter rotating chopping shafts 104 and/or chopping blades 104A may increase agitation of the material in the hopper 106 and/or prolong the time the material is engaged with the chopping blades 104A until being fed to the auger 108A. Increasing agitation of the material in the hopper 106 may allow for improved conditioning of the material.

While the embodiment of FIG. 1 shows three chopping shafts 104 having corresponding sets of chopping blades 104A, in other examples another number of chopping shafts 104 and/or chopping blades 104A are used. In various embodiments, the hopper 106 includes less than three chopping shafts 104 and/or chopping blades 104A, such as one or two, while in other examples the hopper 106 includes more than three chopping shafts 104 and/or blades 104A, such as four or five.

In the embodiment of FIGS. 1-4, the auger 108A is disposed in the hopper 106 and configured to conduct the insulation material received in the material feed opening 107 of the hopper 106 to the outlet 118. The auger 108A is longitudinally disposed along an auger shaft 108, with the auger shaft 108 defining an axis about which the auger 108A rotates. The auger shaft 108 is coupled to opposite walls of the hopper 106. The auger shaft 108 is coupled at an end to the sprocket 102. The sprocket 102 is drivingly engaged with the power source 110 to actuate the auger shaft 108 in the same and/or similar manner as previously described with respect to the conditioning shaft 104. For example, engagement with the power supply 110 causes rotation of the auger shaft 108 which causes rotation of the auger 108.

In the embodiment shown of FIG. 1, the auger 108A includes a single spiral and/or helical flighting (e.g., a helix) mounted to the auger shaft 108. An orientation and/or helical flighting pattern of the auger 108A conducts material along a direction parallel with the auger shaft 108. In examples where the auger shaft 108 is disposed proximate to the outlet 118, the orientation and/or helical flighting pattern of the auger 108A conducts material toward the outlet 118. As shown, a radial outer edge of the helical flighting is crenelated and/or castellated with periodic notches that form generally rectangular blades on the helical flighting.

In various embodiments, a plurality of pins 108C are mounted to the helical flighting shaped auger 108A. The pins 108C are rotationally and angularly aligned with leading edges of the generally rectangular blades. The pins 108C extend radially beyond the radial outer edge of the helical flighting shaped auger 108A, such that the radial outer edge has a shorter radial length than a pin radial length of pins 108C relative to the auger shaft 108. The pins 108C have distal ends that define the pin radial length relative to the auger shaft 108. The pins 108C can aid in breaking apart (e.g., conditioning) the insulating material prior to engagement with the outlet 118.

In various embodiments, the auger shaft 108 further includes one or more paddles 108B mounted to the auger shaft 108 and extending radially outward. In such examples, the one or more paddles 108B are orthogonal to the auger shaft 108. The one or more paddles 108B rotate about the auger shaft 108 in the same and or similar manner as previously described.

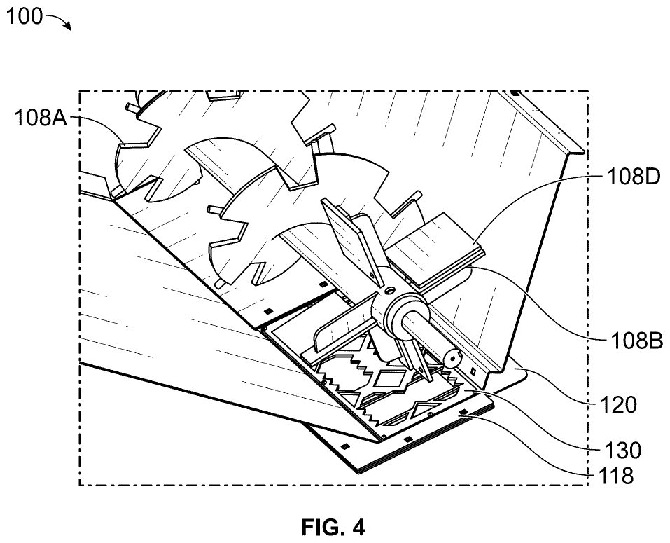

In embodiments, such as the embodiment shown in FIG. 4, at least one of the paddles 108B includes a plate 108D. The plate 108D having a surface that is flat, elongated and rectangular. The plate 108D protrudes from the paddle 108B longitudinally along the auger shaft 108 that the surface is parallel to the auger shaft 108. In various embodiments plate 108D is fixedly coupled to the paddle 108B, such as by welding or fasteners (e.g., nuts, bolts, or rivets). In the example shown, the paddles 108B are radially oriented in a same direction about the auger shaft 108. In such examples, the orientation of the paddles 108B coincides with a direction of rotation of the auger shaft 108. However, in other examples at least one paddle 108B is radially oriented towards a second paddle 108B.

In various embodiments, the paddles 108B and/or plates 108D are oriented about the auger shaft at equal spacing from one another. For example, four paddles 108B having plates 108D are shown in FIG. 4 with each respective paddle/plate combination being spaced approximately 90 degrees from another. While four paddles 108B and four plates 108D are shown, in other examples the auger shaft 108 includes less than four, such as two, or more than four, such as six, paddles 108B and/or plates 108D. In such examples, each paddle 108B is spaced equidistance from another about the auger shaft 108. In examples where two paddles 108B are used, each paddle 108B is disposed at a 180 degree distance of separation from the other. Whereas in examples where six paddles 108B are used, each paddle 108B is disposed at a 60 degree distance of separation from one another. Further, in various embodiments a first paddle 108B is disposed longitudinally along the auger shaft 108 at a distance different than a second paddle 108B, such that the first paddle 108B is closer to a first end of the auger shaft 108 than the second paddle 108B.

In various embodiments, the paddles 108B are proximate to the outlet 118 of the hopper 106. For example, as shown in FIG. 4 the paddles 108B are disposed within the hopper 106 above the outlet 118. The paddles 108B receive and engage the conditioned material conducted by the auger 108A and urge the conditioned material through the outlet 118 for handling by the blower 112.

In the embodiment of FIG. 4, the system 100 includes a plate 130. The plate 130 is operatively disposed between the outlet 118 of the hopper 106 and the blower inlet 112A. In various embodiments, the plate 130 is optionally coupled to a slide gate 120 that is further disposed between the outlet 118 and the blower inlet 112A. The plate 130 is configured to preferentially admit insulation material below a threshold size into the blower 112 and preferentially reject insulation material above the threshold size for reintroduction to the hopper 112 and contact with at least one of the chopping blades 104A. In this embodiment, the paddles 108B engage the insulation material received from the auger to place in communication with the plate 130. In various embodiments, the paddles 108B are further configured to convey insulation material that is rejected by the plate 130 toward one or more of the chopping blades 104A. FIG. 4A is a schematic perspective view of an embodiment of a blower, showing wiper blades that can wipe received insulation material across the plate.

Reintroduction by the paddles 108B of insulation material rejected by the plate 130 may allow the chopping blades 104A to further condition (e.g., shred) the insulation material which may produce more uniform sizing and reduce the presence of clusters. Further, the paddles 108B may present the outlet 118 from becoming clogged by insulation material rejected by the plate 130 which may otherwise require maintenance downtime of the system 100 to resolve.

The blower 112 includes the blower inlet 112A coupled to the outlet 118 of the hopper 106. Upon being accepted through the plate 130, conditioned insulation material exits the outlet 118 of the hopper 106 and enters the blower 112 by way of the blower inlet 112A. As shown in FIG. 1, the blower 112 includes a plurality of sealed vanes 112C. The plurality of sealed vanes 112C rotate around a drum and transport the conditioned insulation material to an area where the air flow from blower 112 carries the conditioned insulation material through the blower outlet 112B. The blower 112 is configured, such as by inclusion of an air lock, to direct the air flow out through the blower outlet 112B rather than back into the hopper 106. Directing air flow out through the blower outlet 112B allows for the insulation material to be pneumatically conveyed through the blower outlet 112B for deposition.

In various embodiments, the blower 112 moves the conditioned insulation material using the plurality of sealed vanes 112C to a position where air from blower 112 can carry the insulation material to an installation site. In various embodiments a hose is coupled to the blower outlet 112B. The hose receives the insulation material exiting the blower outlet 112B and facilitates transfer of said material to the installation site. In such examples, insulation material enters a first end of the hose, coupled to the blower outlet 112B, and travels through the hose to exit at a second end of the hose distal to the first end. The second end of the hose is at the installation site. Pneumatic pressure from the blower 112 facilitates delivery of the insulation material through the hose.

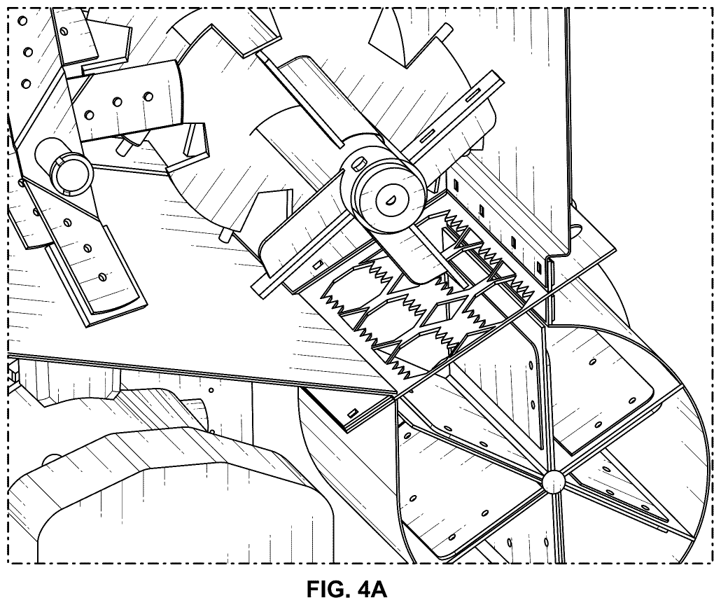

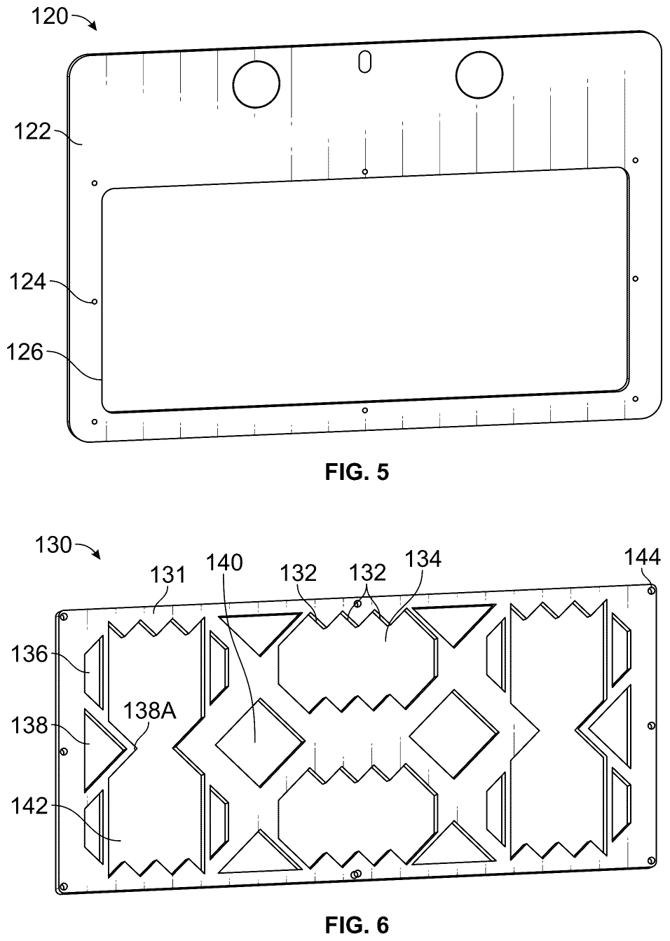

In various embodiments, the system 100 further includes a slide gate, such as the slide gate 120. FIG. 5 shows a perspective view of the slide gate 120 of FIG. 4. The slide gate 120 includes a body 122 defining a plurality of apertures, one or more coupling apertures 124, and a cutout 126.

In various embodiments, the slide gate 120 is disposed between the outlet 118 of the hopper 106 and the blower inlet 112A. In such examples, the body 122 of the slide gate 120 has a rectangular shaped profile generally matching dimensions of the outlet 118 and/or the blower inlet 112A. For example, a perimeter defined by the cutout 126 has dimensions the same as or similar to dimensions of the outlet 118 and/or the inlet 112A. A distance of separation exists between the outlet 118 and the blower inlet 112A allowing the slide gate 120 to be disposed within the distance of separation between the respective parts. In various embodiments, a bracket or flanged lip is present on either the hopper 106 and/or the blower 112 to facilitate retaining of the slide gate 120.

The plurality of apertures defined by the body 122 include the one or more coupling apertures 124 and the cutout 126. The coupling apertures 124 are located along a perimeter of the cutout 126 and facilitate coupling of a mating structure, such as the plate 130. Fasteners, such as screws, nuts/bolts, pins, and/or rivets, are inserted through the mating structure and the coupling apertures 124 of the slide gate 120. In various embodiments, the one or more coupling apertures are threaded to accommodate the fastener (e.g., the screw).

In various embodiments, the slide gate 120 is disposed between the outlet 118 and the blower inlet 112A such that the dimensions of the cutout 126 correspond to the outlet 118 and/or the blower inlet 112A. In such embodiments, insulation material exiting the outlet 118 passes through the cutout 126 before entering the blower inlet 112A. In examples where the plate 130 is coupled to the slide gate 120, insulation material further passes through the plate 130 prior to entering the blower inlet 112A. Thus, in various embodiments the cutout 126 and/or the plate 130 discriminate what insulation material is allowed to exit the outlet 118 and/or be received by the blower inlet 112A. While the cutout 126 is defined by a rectangular profile (e.g., a rectangular perimeter), in other examples the cutout 126 is defined by another shape (e.g., polygonal, circular, oval, annular, and/or arcuate in shape). In various embodiments, the profile shape and/or locations of the coupling apertures 124 of the cutout 126 correspond to a profile shape of the mating structure, such as the body of the plate 130.

In various embodiments, the slide gate 120 is movable between a first position and a second position, where the slide gate 120 is disposed between the outlet 118 of the hopper 106 and the blower inlet 112A to allow material flow therebetween when in the first position, and to block material flow therebetween when in the second position. In examples where the slide gate 120 is coupled to the plate 130, the first position places the plate 130 between the outlet 118 and the blower inlet 112A to allow the insulation material to pass. When the slide gate 120 is moved to the second position, a solid portion of the slide gate 120, such as a portion of the slide gate 120 without the aperture, is disposed between the outlet 118 and the blower inlet 112A such that flow between the outlet 118 and blower inlet 112A is arrested.

In various embodiments, the plate 130 is coupled to the slide gate 120 such that the plate 130 is disposed between the outlet 118 of the hopper 106 and the blower inlet 112A when the slide gate 120 is in the first position, and wherein the slide gate 120 is disposed between the outlet 118 of the hopper 106 and the blower inlet 112A when in the second position.

In other examples, the slide gate 120 is separate from the plate 130 and in the first position material flow through the plate 130 is uninhibited by the slide gate 120, and in the second position a solid portion of the slide gate 120 overlaps with the plate 130 (e.g., disposed over the plate 130) such that material flow through the plate 130 is blocked by the slide gate 120. Thus, in various embodiments the slide gate 120 is configured to slide to block one or more apertures of the plate when in the second position. The slide plate 120 can thus move independent of the plate 130 and pass either over or under the fixed plate 130.

In various embodiments, the slide gate 120 is further movable to a plurality of positions between the first position and the second position. In such examples, each of the plurality of positions between the first position and the second position define an aperture size that material flows through between the outlet 118 and the blower inlet 112A. As such, a rate of material flow between the outlet 118 and blower inlet 112A is adjustably regulated based on each of the plurality of positions. For example, the aperture size allowing material flow between the outlet 118 and the blower inlet 112A becomes progressively smaller as the slide gate 120 is moved to each successive position from the first position to the second position. Thus, starting at the first position and moving to the second position, the material flow rate decreases as the slide gate 120 is moved to each of the plurality of positions.

In another example, a plurality of plates 130 are coupled to the slide gate 120. In such examples, each of the plurality of positions corresponds to each of the plurality of plates 130 disposed between the outlet 118 and the blower inlet 112A. For example, a first plate 130 is disposed between the outlet 118 and the blower inlet 112A when the slide gate 120 is in the first position, and a second plate 130 is disposed between the outlet 118 and the blower inlet 112A when the slide gate 120 is in the second position. In various embodiments, at least one of the plurality of positions of the slide gate 120 blocks material flow between the outlet 118 and the blower inlet 112A.

FIGS. 6-9B show perspective views of various example plates. FIG. 6 shows the plate 130 that is installed on the system 100 in FIG. 4. The plate 130 includes a body 131 and a plurality of apertures, such as a first aperture 134, a second aperture 136, a third aperture 138, a fourth aperture 140, a fifth aperture 142, and coupling apertures 144. In operation, insulation material passes through the first through fifth apertures 134, 136, 138, and 140 in order to enter the blower inlet 112A (FIG. 1). The coupling apertures 144 facilitate coupling of the plate 130 to mating structure, such as coupling to the slide gate 120, the outlet 118 of the hopper 106, or the blower inlet 112A.

In various embodiments, the structure that the plate 130 is coupled to moves between a plurality of positions, such as a first position and a second position. The plate 130 moves with the coupling structure, such that the plate moves between the plurality of positions based on movement of the coupling structure. With respect to FIGS. 1-4, in various embodiments the plate 130 is coupled to the slide gate 120 such that the plate 130 is disposed between the outlet 118 of the hopper 106 and the blower inlet 112A when the slide gate 120 is in the first position, and wherein the slide gate 120 is disposed between the outlet 118 of the hopper 106 and the blower inlet 112A when in the second position.

The plate 130 includes one or more of the first aperture 134, one or more of the second aperture 136, one or more of the third aperture 138, one or more of the fourth aperture 140, and one or more of the fifth aperture 142. Thus, in various embodiments the plate 130 includes a plurality of each of the first through fifth apertures 134, 136, 138, 140, and 142. The first through fifth apertures 134, 136, 138, 140, and 142 restrict insulation material exiting the outlet 118 of the hopper 106. In various embodiments, at least one of the first through fifth apertures 134, 136, 138, 140, and 142 restrict material exiting the outlet 118 of the hopper 106 based on a size of the insulation material. For example, rejecting the insulation material based on the insulation material including clumps/agglomerates and/or being above the threshold size. Each of the first through fifth apertures 134, 136, 138, 140, and 142 have a perimeter defined by the body 131 of the plate 130. In various embodiments, the shape, defined by the perimeter, of the first aperture 134 is different than the shape of the second aperture 136. In other examples, the shape of each of the first through fifth apertures 134, 136, 138, 140, and 142 is different from one another.

In various embodiments, at least one of the apertures is polygonal in shape. For example, at least one of the first through fifth apertures 134, 136, 138, 140, and 142 of plate 130 is defined by the polygonal shaped perimeter. In another example, each of the first through fifth apertures 134, 136, 138, 140, and 142 on the plate 130 are defined by a polygonal shaped perimeter. In various embodiments, one or more polygons are partially defined by a same perimeter. For instance, a portion of the perimeter defining one of the third apertures 138 partially defines a portion of the perimeter defining one of the fifth apertures 142.

In such examples, the portion of the perimeter defining one of the third apertures 138 protrudes into the fifth aperture 142 such that a sharp corner 138A partially defines the fifth aperture 142. Within such examples, the sharp corner 138A elongates the insulation material passing through the plate 130 and entering the blower inlet 112A. However, in other examples at least one of the first through fifth apertures 134, 136, 138, 140, and 142 is defined by the polygonal shaped perimeter and at least one of the first through fifth apertures 134, 136, 138, 140, and 142 is defined by another shaped perimeter, such as an annular shaped perimeter or an arcuate shaped perimeter.

In various embodiments, at least one of the first through fifth apertures 134, 136, 138, 140, and 142 is defined by a polygon having a serrated profile 132 on at least one side, where the serrated profile 132 elongates the insulation material prior to being admitted to the blower 112. For example, the first aperture 134 is further defined by the serrated profile 132. In various embodiments, the serrated profile 132 defines a jagged and/or sawlike portion of the aperture such that the serrated profile 132 portion of the aperture includes a plurality of acute angled portions protruding inwardly towards a center of the aperture. Serrations can also be formed by comb-like protrusions into the aperture. During use of the system 100 (FIG. 1) at least some insulation material placed in communication with the plate 130 may not be fully conditioned (e.g., cut apart, opened and/or elongated) which may affect thermal insulating properties after deposition. The serrated profile 132 catches some of the insulation material passing through the plate 130 and elongates the insulation material prior to entering the blower inlet 112A. In such examples, after catching the insulation material pulling (e.g., suction) forces induced by the blower 112 assist the serrated profile 132 in elongation. The wiping blades shown in FIG. 4A can also help to pull the insulation across the serrations, causing it to be further conditioned by pulling to cause an expansion in volume.

In various embodiments, the plate 130 defines a first aperture having a first size and a second aperture having a second size different than the first size. For example, the first aperture 134 is defined by the first size and the second aperture 136 is defined by the second size being different than the first size. In further examples, the plate 130 defines a different size for each of the first through fifth apertures 134, 136, 138, 140, and 142.

In various embodiments, the plate 130 defines a first aperture having a first polygonal shape and a second aperture having a second polygonal shape different than the first polygonal shape. For example, the first aperture 134 is defined by the first polygonal shape and the second aperture 136 is defined by the second polygonal shape being different than the first polygonal shape. In further examples, the plate 130 defines different polygonal shapes for each of the first through fifth apertures 134, 136, 138, 140, and 142. In various embodiments, the first polygonal shaped aperture, such as the first aperture 134, is larger than the second polygonal shaped aperture, such as the second aperture 136.

In various embodiments, the threshold size is no more than 5 inches, e.g., no more than 4.5 inches, or no more than 4 inches. In various embodiments, the threshold size is no more than 3.5 inches, e.g., no more than 3 inches, or no more than 2.5 inches, or no more than 2 inches. In various embodiments, the threshold size is in the range of 1-5 inches. For example, in various embodiments, the threshold size is in the range of 1-4.5 inches, or 1-4 inches, or 1-3.5 inches, or 1-3 inches, or 1-2.5 inches or 1-2 inches. In various embodiments, the threshold size is in the range of 1.5-5 inches, e.g., 1.5-4.5 inches, or 1.5-4 inches, or 1.5-3.5 inches, or 1.5-3 inches, or 1-2.5 inches. In various embodiments, the threshold size is in the range of 2-4.5 inches, or 2-4 inches, or 2-3.5 inches, or 2-3 inches. In various embodiments, the threshold size is in the range of 2.5-5 inches, e.g., 2.5-4.5 inches, or 2.5-4 inches, or 2.5-3.5 inches. In various embodiments, the threshold size is in the range of 3-4.5 inches, or 3-4 inches. In various embodiments, the threshold size is in the range of 3.5-5 inches, e.g., 3.5-4.5 inches, or 4-5 inches.

In various embodiments as otherwise described herein, the apertures of the plate have a maximum dimension no greater than the threshold size. This can aid in sizing the insulation material, such that clumps larger than the threshold size are preferentially rejected from passing into the blower, and thus can be passed through the chopping blades for further conditioning.

In various embodiments, the system is configured such that at least 75 wt % (e.g., at least 90 wt %) of the insulation material admitted to the blower through the plate has a maximum dimension no greater than the threshold size. For example, in various embodiments as described with respect to the figures, one or more of the first through fifth apertures 134, 136, 138, 140, and 142 has a size based on the insulation material size desired to enter the blower 112. In such examples, the size of the insulation material allowed to pass through one or more of the apertures is the threshold size, such that the plate 130 generally admits insulation material below the threshold size into the blower 112 and rejects insulation material above the threshold size. Selectively admitting the insulation material below the threshold size may allow for more uniform insulation material to be deposited at the installation site which may reduce inconsistencies in deposition and increase thermal insulation and cosmetic properties.

In various embodiments, the system is configured such that the insulation material admitted to the blower through the plate has a density of no more than 50% of the density of material admitted to the hopper, for example, no more than 35%, or no more than 25%. For example, in various embodiments, the system is configured such that the insulation material admitted to the blower through the plate has a density of in the range of 2-50% of the density of material admitted to the hopper, e.g., in the range of 2-35%, or 2-25%, or 2-15%, or 2-10%, or 2-6%. In various embodiments, the system is configured such that the insulation material admitted to the blower through the plate has a density of in the range of 4-50% of the density of material admitted to the hopper, e.g., in the range of 4-35%, or 4-25%, or 4-15%, or 4-10%, or 4-8%. In various embodiments, the system is configured such that the insulation material admitted to the blower through the plate has a density of in the range of 10-50% of the density of material admitted to the hopper, e.g., in the range of 10-35%, or 10-25%, or 10-20%, or 10-15%. In various embodiments, the system is configured such that the insulation material admitted to the blower through the plate has a density of in the range of 15-50% of the density of material admitted to the hopper, e.g., in the range of 15-35%, or 15-30%, or 15-25%, or 15-20%. The present inventors have determined that the relatively longer residence time in the hopper, and/or, when present, contact of the insulation with the serrations on the plate, can act to further reduce the density of the insulation material, by causing more pulling of the insulation material by blades disposed in the hopper, and/or by grabbing of the insulation material by the serrations. The person of ordinary skill in the art can, based on the present disclosure, select larger aperture sizes to give relatively less materials.

While the first through fifth apertures 134, 136, 138, 140, and 142 are described with respect to the example plate 130, in other examples the plate 130 includes another number of apertures.

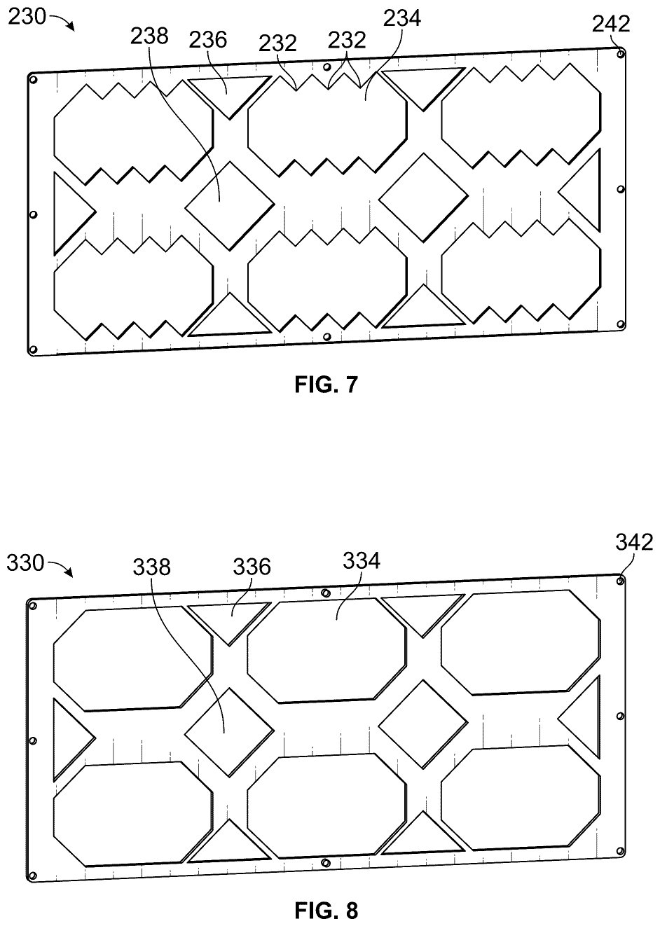

For example, FIG. 7 shows a perspective view of another plate 230 having a different number and arrangement of apertures as compared to FIG. 6, according to various embodiments. Plate 230 includes a first aperture 234, a second aperture 236, a third aperture 238, and a plurality of coupling apertures 242. The first aperture 234 is partially defined by a serrated profile 232. FIG. 8 shows a perspective view of another plate 330 according to various embodiments. The plate 330 includes a first through third aperture 334, 336, and 338, and a plurality of coupling apertures 342. Unlike the plate 230 shown in FIG. 7, the first through third apertures 334, 336, 338 do not include the serrated profile. The plate 230 can be otherwise similar plate described with respect to FIG. 6.

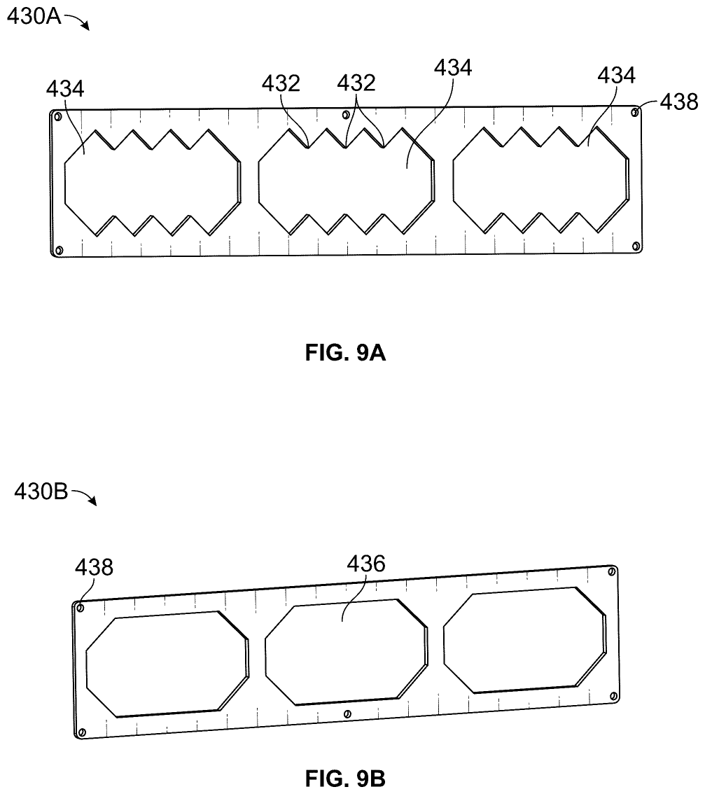

FIGS. 9A and 9B show perspective views of a first plate portion 430A and a second plate portion 430B, according to various embodiments. The first plate portion 430A includes at least one first aperture 434 having a serrated profile 432, and a plurality of coupling apertures 438. The second plate portion 430B includes at least one second aperture 436 and a second plurality of the coupling apertures 438.

In various embodiments, the first aperture 434 has a different shape and/or size than the second aperture 436, as previously described with respect to any of the apertures of plate 130 (FIG. 6). In various embodiments, the serrated profile 432 included on the first aperture 434 elongates the insulation material passing through the first plate portion 430A as the insulation material enters the blower inlet 112A. In such examples, insulation material passing through the second aperture 436 on the second plate portion 430B is not elongated by the second plate portion 430B as the insulation material enters the blower inlet 112A.

In various embodiments, the first aperture 434 and the second aperture 436 define a threshold size of insulation material that is admitted through the first and second plate portions 430A and 430B. In other examples, the first aperture 434 defines a first threshold size and the second aperture 436 defines a second threshold size different than the first threshold size of insulation material admitted through each of the respective first and second plate portions 430A and 430B. In various embodiments, the first threshold size is smaller than the second threshold size, while in other examples the second threshold size is smaller than the first threshold size.

In various embodiments, the first plate portion 430A is coupled, by way of the coupling apertures 438, to a first portion of the slide gate 120 and the second plate portion 430B is coupled, by way of the coupling apertures 438, to a second portion of the slide gate 120. In such examples, the slide gate 120 is movable between a first portion and a second position such that in the first position the first plate portion 430A is disposed between the outlet 118 and the blower inlet 112A and in the second position the second plate portion 430B is disposed between the outlet 118 and the blower inlet 112A. As such, insulation material is selectively admitted through the first aperture 434 when the slide gate 120 is in the first position and selectively admitted through the second aperture 436 when the slide gate 120 is in the second position. Thus, in various embodiments the slide gate 120 admits a first size and/or shape of insulation material into the blower inlet 112A when the slide gate 120 is in the first position and admits a second size and/or shape of insulation material into the blower inlet 112A when the slide gate 120 is in the second position. In such examples, the size and/or shape of insulation material admitted into the blower inlet 112A is based on the presence of either the first or second plate portion 430A or 430B disposed between the outlet 118 and the blower inlet 112A.

Another embodiment of a plate is shown in plan view in FIG. 10. Here, plate 530 is analogous to plate 230 of FIG. 7, but with the polygonal first apertures subdivided even more with additional serrated edges.

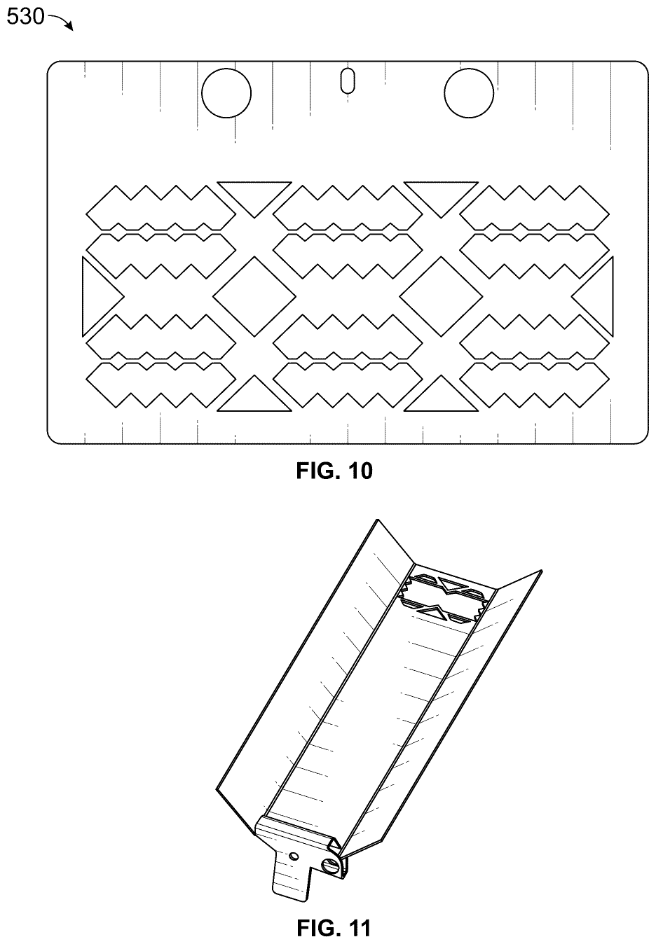

The plates are shown in the above-described figures as being flat pieces of material. These can be installed, for example, in the Bolt™ 3 insulation blowing machine (CertainTeed). But the person of ordinary skill in the art will appreciate that the plate can be provided in a number of forms, depending on the insulation blower with which it is to be used. As one example, the slide gate of the Volu-Matic™ machine (CertainTeed) has a more complex design; the plate of the disclosure can be provided as part of the flat surface that fits between hopper and blower. One example of such a gate is shown in FIG. 11.

Plates for use in the methods and systems described herein can be made from a variety of materials. In various desirable embodiments, the plate is made from metal such as a steel material. But other materials like plastics, ceramics and wood can also be used.

In another aspect, the disclosure provides a method of processing insulation fibers using the system of the disclosure. The method includes introducing loose fill insulation material into the hopper. The loose fill insulation material is conditioned by contacting with one or more of the chopping blades to reduce the size of the insulation material. The reduced-size loose fill insulation material is conveyed, via the auger, to the outlet of the hopper. The reduced-size insulation material is sized, using the plate, to preferentially admit insulation material below a threshold size into the blower and preferentially reject insulation material above the threshold size. The rejected insulation material is reintroduced to the hopper for contact with at least one of the chopping blades.

Such a method is depicted in FIGS. 1-4. Packed insulation material 190 is initially introduced into system 100 via the feed material opening 107 of the hopper 106. The packed insulation material 190 is conditioned (e.g., broken up and opened) by the one or more chopping blades 104A to reduce the size of the insulation material. The reduced-size insulation material is placed in communication with the auger 108A. The reduced-size insulation material is conveyed, via the auger 108A, to the outlet 118 of the hopper 106. The plate 130 disposed between the outlet 118 of the hopper 106 and the blower inlet 112A sizes the reduced-size insulation material to preferentially admit insulation material below a threshold size into the blower 112 and preferentially reject insulation material above the threshold size. The rejected insulation material, such as the insulation material that does not pass through the plate 130, is reintroduced to the hopper 106 for contact with at least one of the chopping blades 104A. In various embodiments, one or more of the paddles 108B reintroduce the rejected insulation material back into the hopper 106.

In various embodiments of the method as otherwise described herein, the method further includes opening the loose fill insulation material that is passing through the plate 130 using one or more apertures located on the plate 130. In such examples, at least one aperture on the plate 130 includes a serrated profile that further opens the loose fill insulation material.

In various embodiments of the method as otherwise described herein, the loose fill insulation includes a fibrous material. For example, in various embodiments, the loose fill insulation is a fiberglass insulation, a cellulose insulation, a stonewool insulation, a plastic fiber insulation, a natural wool insulation, a natural cotton insulation, or another insulation including fibers. In other examples, the loose fill insulation includes small insulating components, such as a foam bead insulation or a plastic particle insulation. Still, in other examples, the loose fill insulation may be formed of another type of insulation that can be processed by the system 100.

The methods of the disclosure can generally be performed as described above with respect to systems.

The systems and methods of the disclosure were tested using a Bolt™ 3 insulation blowing machine (CertainTeed LLC). Plate 130 of FIG. 6 and plate 530 of FIG. 10 were used. The plate was installed in the position between the hopper and the blower, i.e., where the slide gate is typically positioned. The air speed control was set at 11. The same 100 foot hose (first 50 feet, 3″ diameter; second 50 feet, 2″ diameter) was used in all cases. As a comparative example, a test was performed with the slide gate 50% closed (i.e., to occlude ½ of the aperture between the hopper and the blower). Results are shown in the table below:

| | Control | Plate 130 | Plate 530. |
|---|---|---|---|
| k at 6.30″ | 0.3903 | 0.4494 | 0.4279 |
| k at 6.00″ | 0.3755 | 0.4318 | 0.4111 |
| k at 5.70″ | 0.3615 | 0.4153 | 0.3963 |
| 10 × 10 weight at 6″, g | 100.48 | 64.17 | 55.42 |
| 10 × 10 density at 6″, | 0.61 | 0.39 | 0.34 |
| lbs per cubic foot | | | |
| Outside weight, g. | 437.76 | 285.8 | 266.48 |
| N′ at 6.00″ | 8.25 | 9.848 | 12.463 |
| Blowing speed | Normal | Slower | Slowest |

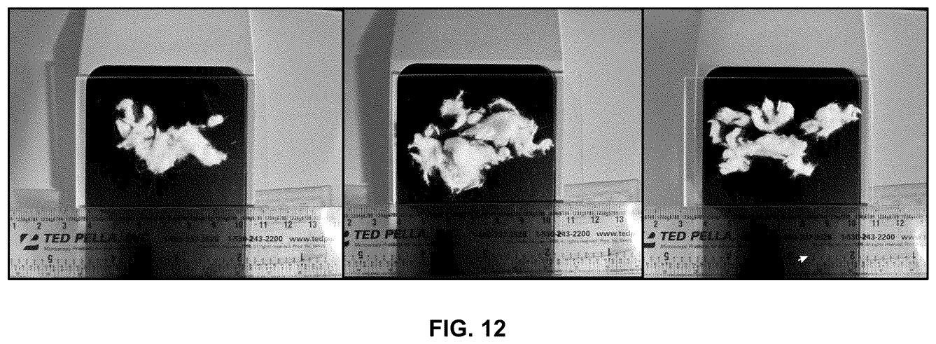

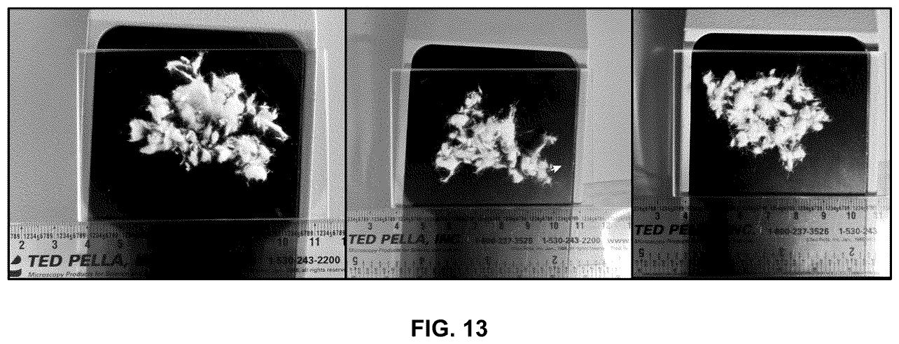

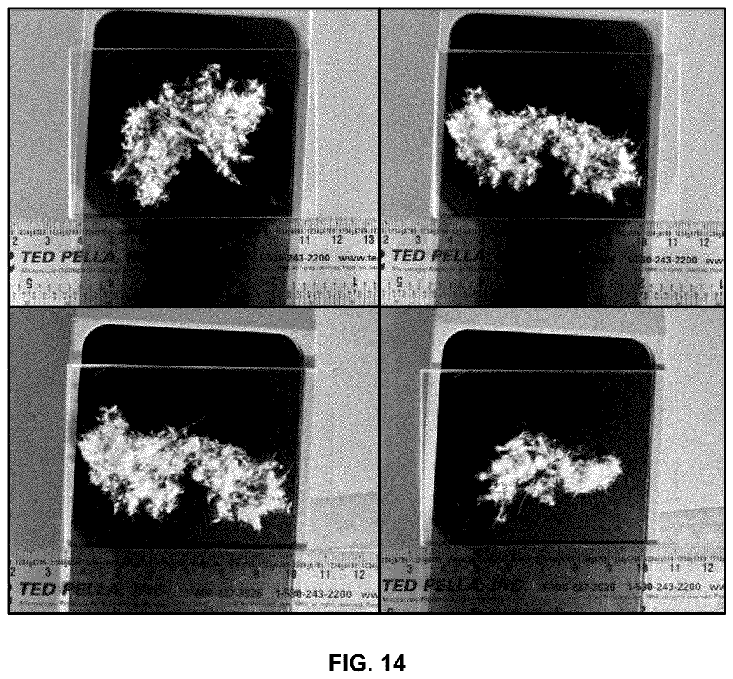

Photographs were taken of samples of blown insulation. FIG. 12 provides three pictures of insulation material blown in the control experiment; FIG. 13 provides three pictures of insulation material blown in the experiment with plate 130, and FIG. 14 provides four pictures of insulation material blown in the experiment with plate 530. The pictures demonstrate that the insulation material blown using the plates of the disclosure is less dense and more lofty in appearance.

The data demonstrate that the use of the plates of the disclosure can increase thermal performance and decrease density of a blown insulation as compared to the use of a conventional slide gate, with the plate with smaller apertures and more serrations providing the highest thermal performance and lower density of the three.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

Various aspects and embodiments of the disclosure are provided by the following non-limiting enumerated embodiments, which may be combined in any number and in any fashion not logically or technically inconsistent.
Embodiment 1. A system for processing insulation material, comprising:
   a hopper having a material feed opening configured to receive insulation material and an outlet;
   at least one chopping blade disposed in the hopper, configured to reduce the size of insulation material disposed therein;
   an auger disposed in the hopper and configured to conduct insulation material received in the material feed opening of the hopper to the outlet of the hopper;
   a blower having an inlet coupled to the outlet of the hopper and an outlet, the inlet of the blower being configured to receiving insulation material from the hopper and to blow it through the outlet of the blower;
   a plate operatively disposed between the outlet of the hopper and the inlet of the blower, the plate defining a plurality of apertures, wherein
      (a) the plate is configured to preferentially admit insulation material below a threshold size into the blower and preferentially reject insulation material above the threshold size for reintroduction to the hopper and contact with at least one of the chopping blades; and/or
      (b) the apertures of the plate have a maximum dimension no greater than the threshold size.
Embodiment 2. The system of embodiment 1, further comprising a slide gate movable between a first position and a second position, wherein the slide gate is disposed between the outlet of the hopper and the inlet of the blower to allow material flow therebetween when in the first position, and to block material flow therebetween when in the second position
Embodiment 3. The system of embodiment 2, wherein the slide gate is further movable to a plurality of positions between the first position and the second position.
Embodiment 4. The system of any of embodiments 2 to 3, wherein the slide gate is configured to slide to block one or more apertures of the plate when in the second position.
Embodiment 5. The system of embodiment 2, wherein the plate is coupled to the slide gate such that the plate is disposed between the outlet of the hopper and the inlet of the blower when the slide gate is in the first position, and wherein the slide gate is disposed between the outlet of the hopper and the inlet of the blower when in the second position.
Embodiment 6. The system of any of embodiments 1 to 5, wherein at least one of the apertures is polygonal in shape.
Embodiment 7. The system of any of embodiment 1 to 6, wherein at least one of the apertures is defined by a polygon having a serrated profile on at least one side, wherein the serrated profile elongates the material prior to being admitted to the blower.
Embodiment 8. The system of any of embodiments 1 to 7, wherein the plate defines a first aperture having a first size and a second aperture having a second size different than the first size.
Embodiment 9. The system of any of embodiments 1 to 8, wherein the plate defines a first aperture having a first polygonal shape and a second aperture having a second polygonal shape different than the first polygonal shape.
Embodiment 10. The system of embodiment 9, wherein the first polygonal shaped aperture is larger than the second polygonal shaped aperture.
Embodiment 11. The system of any of embodiments 8 to 10, wherein the first aperture is further defined by a serrated profile.
Embodiment 12. The system of any of embodiments 1 to 11, wherein the system is configured such that at least 75 wt % (e.g., at least 90 wt %) of the insulation material admitted to the blower through the plate has a maximum dimension no greater than the threshold size.
Embodiment 13. The method of any of embodiments 1-12, configured such that the insulation material admitted to the blower through the plate has a density of no more than 50% of the density of insulation material introduced to the hopper, e.g., no more than 35%, or no more than 25%.
Embodiment 14. The method of any of embodiments 1-12, configured such that the insulation material admitted to the blower through the plate has a density in the range of 2-50% of the density of insulation material introduced to the hopper, e.g., in the range of 2-35%, or 2-25%, or 2-15%, or 2-10%, or 2-6%.
Embodiment 15. The method of any of embodiments 1-12, configured such that the insulation material admitted to the blower through the plate has a density in the range of 4-50% of the density of material admitted to the hopper, e.g., in the range of 4-35%, or 4-25%, or 4-15%, or 4-10%, or 4-8%.
Embodiment 16. The method of any of embodiments 1-12, configured such that the insulation material admitted to the blower through the plate has a density in the range of 10-50% of the density of material admitted to the hopper, e.g., in the range of 10-35%, or 10-25%, or 10-20%, or 10-15%.
Embodiment 17. The method of any of embodiments 1-12, configured such that the insulation material admitted to the blower through the plate has a density in the range of 15-50% of the density of material admitted to the hopper, e.g., in the range of 15-35%, or 15-30%, or 15-25%, or 15-20%.
Embodiment 18. The system of any of embodiments 1 to 17, wherein the auger comprises a shaft with an axis about which the auger rotates; and a helical flighting mounted to the shaft.
Embodiment 19. The system of embodiment 18, wherein the auger further comprises a set of paddles mounted to the shaft and disposed proximate to the outlet of the hopper.
Embodiment 20. The system of embodiment 19, wherein the set of paddles engage the insulation material received from the auger to place in communication with the plate.
Embodiment 21. The system of embodiment 19 or embodiment 20, wherein the paddles are configured to convey insulation material that is rejected by the plate toward one or more of the chopping blades.
Embodiment 22. The system of any of embodiments 1 to 21, wherein the one or more chopping blades are disposed on one or more rotatable shafts disposed within the hopper.
Embodiment 23. The system of embodiment 22, wherein the one or more chopping blades advance conditioned material to the auger.
Embodiment 24. The system of any of embodiments 1 to 23, wherein the hopper includes an inclined bottom surface coupled at a first end to the outlet and at a second end to a wall, the bottom surface sloping downwardly toward the outlet.
Embodiment 25. The system of any of embodiments 22 to 24, wherein at least one shaft bearing chopping blades and the auger are counter-rotating.
Embodiment 26. The system of any of embodiments 1 to 25, further comprising a delivery hose having a first end coupled to the outlet of the blower.
Embodiment 27. A method of processing insulation fibers using the system according to any of embodiments 1 to 26, the method comprising:
   introducing loosefill insulation material into the hopper;
   conditioning the loosefill insulation material by contacting with one or more of the chopping blades to reduce the size of the insulation material;
   conveying, via the auger, the reduced-size insulation to the outlet of the hopper;
   sizing, using the plate, the reduced-size insulation to preferentially admit insulation material below a threshold size into the blower and preferentially reject insulation material above the threshold size;
   reintroducing rejected insulation material the hopper and contacting it with at least one of the chopping blades.
Embodiment 28. The method of embodiment 27, wherein at least 75 wt % (e.g., at least 90 wt %) of the insulation material admitted to the blower has a maximum dimension of no greater than the threshold size.
Embodiment 29. The method of embodiment 27 or embodiment 28, wherein the insulation material admitted to the blower through the plate has a density of no more than 50% of the density of insulation material introduced to the hopper, e.g., no more than 35%, or no more than 25%.
Embodiment 30. The method of embodiment 27 or embodiment 28, wherein the insulation material admitted to the blower through the plate has a density in the range of 2-50% of the density of insulation material introduced to the hopper, e.g., in the range of 2-35%, or 2-25%, or 2-15%, or 2-10%, or 2-6%.
Embodiment 31. The method of embodiment 27 or embodiment 28, wherein the insulation material admitted to the blower through the plate has a density in the range of 4-50% of the density of material admitted to the hopper, e.g., in the range of 4-35%, or 4-25%, or 4-15%, or 4-10%, or 4-8%.
Embodiment 32. The method of embodiment 27 or embodiment 28, wherein the insulation material admitted to the blower through the plate has a density in the range of 10-50% of the density of material admitted to the hopper, e.g., in the range of 10-35%, or 10-25%, or 10-20%, or 10-15%.
Embodiment 33. The method of embodiment 27 or embodiment 28, wherein the insulation material admitted to the blower through the plate has a density in the range of 15-50% of the density of material admitted to the hopper, e.g., in the range of 15-35%, or 15-30%, or 15-25%, or 15-20%.
Embodiment 34. The method or system of any of embodiments 1-33, wherein the threshold size is no more than 5 inches, e.g., no more than 4.5 inches, or no more than 4 inches.
Embodiment 35. The method or system of any of embodiments 1-33, wherein the threshold size is no more than 3.5 inches, e.g., no more than 3 inches, or no more than 2.5 inches, or no more than 2 inches.
Embodiment 36. The method or system of any of embodiments 1-33, wherein the threshold size is in the range of 1-5 inches.
Embodiment 37. The method or system of any of embodiments 1-33, wherein the threshold size is in the range of 1-4.5 inches, or 1-4 inches, or 1-3.5 inches, or 1-3 inches, or 1-2.5 inches or 1-2 inches.
Embodiment 38. The method or system of any of embodiments 1-33, wherein the threshold size is in the range of 1.5-5 inches, e.g., 1.5-4.5 inches, or 1.5-4 inches, or 1.5-3.5 inches, or 1.5-3 inches, or 1-2.5 inches.
Embodiment 39. The method or system of any of embodiments 1-33, wherein the threshold size is in the range of 2-4.5 inches, or 2-4 inches, or 2-3.5 inches, or 2-3 inches.
Embodiment 40. The method or system of any of embodiments 1-33, wherein the threshold size is in the range of 2.5-5 inches, e.g., 2.5-4.5 inches, or 2.5-4 inches, or 2.5-3.5 inches.
Embodiment 41. The method or system of any of embodiments 1-33, wherein the threshold size is in the range of 3-4.5 inches, or 3-4 inches.
Embodiment 42. The method or system of any of embodiments 1-33, wherein the threshold size is in the range of 3.5-5 inches, e.g., 3.5-4.5 inches, or 4-5 inches.

What is claimed is:

1. A system for processing insulation material, comprising:
a hopper having a material feed opening configured to receive insulation material and an outlet;
at least one chopping blade disposed in the hopper, configured to reduce the size of insulation material disposed therein;
an auger disposed in the hopper and configured to conduct insulation material received in the material feed opening of the hopper to the outlet of the hopper;
a blower having an inlet coupled to the outlet of the hopper and an outlet, the inlet of the blower being configured to receiving insulation material from the hopper and to blow it through the outlet of the blower;
a plate operatively disposed between the outlet of the hopper and the inlet of the blower, the plate defining a plurality of apertures, wherein
(a) the plate is configured to preferentially admit insulation material below a threshold size into the blower and preferentially reject insulation material above the threshold size for reintroduction to the hopper and contact with at least one of the chopping blades; and/or
(b) the apertures of the plate have a maximum dimension no greater than the threshold size.

2. The system of claim 1, further comprising a slide gate movable between a first position and a second position, wherein the slide gate is disposed between the outlet of the hopper and the inlet of the blower to allow material flow therebetween when in the first position, and to block material flow therebetween when in the second position.

3. The system of claim 2, wherein the slide gate is further movable to a plurality of positions between the first position and the second position.

4. The system of claim 2, wherein the slide gate is configured to slide to block one or more apertures of the plate when in the second position.

5. The system of claim 2, wherein the plate is coupled to the slide gate such that the plate is disposed between the outlet of the hopper and the inlet of the blower when the slide gate is in the first position, and wherein the slide gate is disposed between the outlet of the hopper and the inlet of the blower when in the second position.

6. The system of claim 1, wherein at least one of the apertures is defined by a polygon having a serrated profile on at least one side, wherein the serrated profile elongates the material prior to being admitted to the blower.

7. The system of claim 1, wherein the plate defines a first aperture having a first size and a second aperture having a second size different than the first size.

8. The system of claim 7, wherein the first aperture is further defined by a serrated profile.

9. The system of claim 1, wherein the system is configured such that at least 75 wt % of the insulation material admitted to the blower through the plate has a maximum dimension no greater than the threshold size.

10. The system of claim 1, configured such that the insulation material admitted to the blower through the plate has a density of no more than 50% of the density of insulation material introduced to the hopper.

11. The system of claim 1, configured such that the insulation material admitted to the blower through the plate has a density in the range of 4-50% of the density of material admitted to the hopper.

12. The system of claim 1, configured such that the insulation material admitted to the blower through the plate has a density in the range of 15-50% of the density of material admitted to the hopper.

13. The system of claim 1, wherein the auger comprises
a shaft with an axis about which the auger rotates; and a helical flighting mounted to the shaft and
a set of paddles mounted to the shaft and disposed proximate to the outlet of the hopper,
wherein the set of paddles are configured to engage the insulation material received from the auger to place in communication with the plate, and to convey insulation material that is rejected by the plate toward one or more of the chopping blades.

14. The system of claim 1, wherein the one or more chopping blades are disposed on one or more rotatable shafts disposed within the hopper, wherein the one or more chopping blades advance conditioned material to the auger.

15. A method of processing insulation fibers using the system of claim 1, the method comprising:
introducing loosefill insulation material into the hopper;
conditioning the loosefill insulation material by contacting with one or more of the chopping blades to reduce the size of the insulation material;
conveying, via the auger, the reduced-size insulation to the outlet of the hopper;
sizing, using the plate, the reduced-size insulation to preferentially admit insulation material below a threshold size into the blower and preferentially reject insulation material above the threshold size;
reintroducing rejected insulation material the hopper and contacting it with at least one of the chopping blades.

16. The method of claim 15, wherein at least 90 wt % of the insulation material admitted to the blower has a maximum dimension of no greater than the threshold size.

17. The method of claim 15, wherein the insulation material admitted to the blower through the plate has a density of no more than 35% of the density of insulation material introduced to the hopper.

18. The method of claim 15, wherein the insulation material admitted to the blower through the plate has a density in the range of 10-50% of the density of material admitted to the hopper.

19. The method of claim 15, wherein the threshold size is no more than 3 inches.

20. The method of claim 15, wherein the threshold size is in the range of 1-5 inches.
